(19) United States
(12) Patent Application Publication
(10) Pub. No.: US 2026/0205502 A1
(43) Pub. Date: Jul. 16, 2026

(54) METHODS AND SYSTEMS FOR MANAGING VOIP CALL QUALITY

(71) Applicant: Comcast Cable Communications, LLC, Philadelphia, PA (US)

(72) Inventors: Vikas Godara, Philadelphia, PA (US); Brett Sherman, Philadelphia, PA (US)

(21) Appl. No.: 19/018,911

(22) Filed: Jan. 13, 2025

(51) Int. Cl. H04L 65/1083; H04L 65/1104; H04L 65/80

(52) U.S. Cl. CPC H04L 65/1083; H04L 65/1104; H04L 65/80

(57) ABSTRACT

Methods, apparatuses, and systems are described for managing a connection quality of a communication session are described. Based on a quality metric associated with a communication session a decision may be made to migrate the communication session to a new computing device. Based on the decision, a new computing device for the communication session may be determined. A first message may be sent to the new computing device and a second message may be sent to the user device. The communication session may be established via the new computing device while maintaining the communication session via a current computing device.

### BACKGROUND

Voice over Internet Protocol (VoIP) networks experience issues related to quality when trying to route voice calls through an Internet protocol network due to the constant change in the quality of the connections as a result of network condition changes. Changes in communication channel conditions can result in packet loss, delay, and jitter, which ultimately affect the audio quality of the voice communication. Moreover, when a caller dials a number to initiate a call and the quality of the connection drops, the caller has to disconnect the call and dial the number again in order to establish a new connection with a better call quality. However, there is no guarantee that the call quality will improve as there are chances that the call may be routed via the same media server experiencing the same connection quality issues. In addition, the calling party’s network bandwidth is not considered during the issue regarding the connection quality. These and other shortcomings are identified and addressed by the disclosure.

### SUMMARY

It is to be understood that both the following general description and the following detailed description are examples and explanatory only and are not restrictive. Methods, systems, and apparatuses for managing the connection quality of a communication session are described.

A communication session may be established through an initial computing device to connect two or more user devices. If the communication session quality drops, a decision may be triggered to migrate the communication session to a different computing device without disconnecting the communication session between the two or more user devices. Based on the decision, a second computing device may be identified from several computing devices configured to provide the communication session based on one or more parameters associated with the second computing device. The communication session may be established through the second computing session while the communication session is maintained through the initial computing device such that the communication session is not disconnected when the communication session is established through the second computing device. Once the communication session is established through the second computing device, the communication session through the initial computing device may be dropped.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 shows an example system;

FIG. 2 shows an example communication session migration process;

FIGS. 3A-3C show an example scenario;

FIG. 4 shows an example system environment;

FIG. 5 shows a flowchart of an example method;

FIG. 6 shows a flowchart of an example method;

FIG. 7 shows a flowchart of an example method; and

FIG. 8 shows a block diagram of an example system and computing device.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

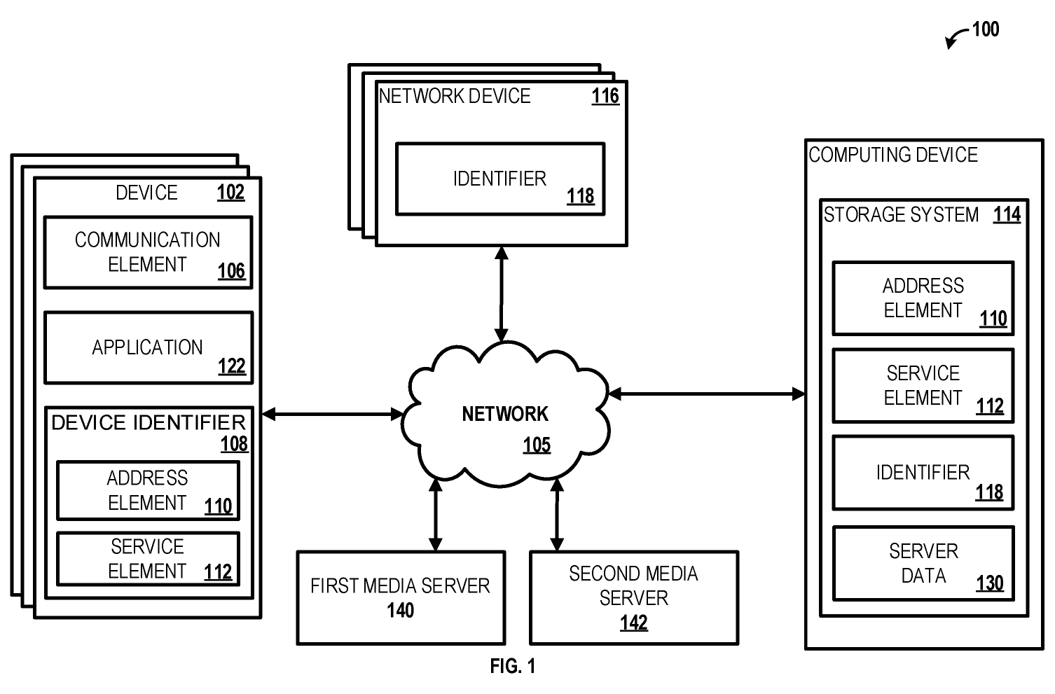

FIG. 1 shows an example system 100 for managing a connection quality of a communication session (e.g., voice over Internet protocol (VoIP)). For example, a communication session via a first computing device may be established between two or more user devices. Based on a quality metric associated with the communication session, the communication session may be caused to continue via a second computing device while maintaining the communication session via the first computing device such that the communication session is not disconnected when the communication session is established through the second computing device. After the communication session via the second computing device is established, the communication session via the first computing device may be dropped (e.g., terminated). The network and system 100 may be configured to provide services, such as network-related services, to one or more user devices (e.g., devices 102). The system 100 may comprise a plurality of devices 102, a plurality of network devices 116, and/or a computing device 104. Each of the plurality of devices 102 may be in communication with each of the plurality of network devices 116, such as a plurality of wireless access points (e.g., gateway devices) and/or a plurality of LTE back-up devices, for example. The computing device 104 may be disposed locally or remotely relative to the devices 102. Each of the network devices 116 may facilitate access to the network 105 for each of the devices 102 and/or the computing device 104. For example, the devices 102 and the computing device 104 may be in communication via a private and/or public network 105 such as the Internet or a local area network (LAN) via the network devices 116. The network devices 116 may be in communication with a computing device 104 such as a centralized device or a server, for example. Other forms of communications can be used such as wired and wireless telecommunication channels.

The devices 102 may comprise electronic devices such as a computer, a smartphone, a laptop, a tablet, a set top box, a display device, a printer, a telephone, a network device, a communication terminal, a transmitter, or other device capable of communicating with the network devices 116. As an example, the devices 102 may comprise communication elements 106 for offering an interface to a user to interact with the devices 102 and/or the computing device 104. The communication elements 106 can be any interface for presenting and/or receiving information to/from the user, such as media content. An example interface may be a communication interface such as a web browser (e.g., Internet Explorer^{®}, Mozilla Firefox^{®}, Google Chrome^{®}, Safari^{®}, or the like). Other software, hardware, and/or interfaces can be used to facilitate communication between the user and one or more of the devices 102 and one or more of the network devices 116. As an example, the communication elements 106 can request or query various files from a local source and/or a remote source. As an example, the communication elements 106 can transmit data to a local or remote device such as the network devices 116 or the computing device 104 via the network devices 116.

The devices 102 may be associated with user identifiers or device identifiers 108. As an example, each of the device identifiers 108 may comprise any identifier, token, character, string, or the like, for differentiating one user or user device (e.g., a device 102) from another user or user device (e.g., another device 102). The device identifiers 108 may each identify each user or each user device as belonging to a particular class of users or user devices. As an example, each of the device identifiers 108 may comprise information relating to each device 102 such as a manufacturer, a model or type of device, a service provider associated with each device 102, a state of each device 102, a locator, and/or a label or classifier. Other information can be represented by the device identifiers 108.

The device identifiers 108 may comprise address elements 110 and service elements 112. The address elements 110 may comprise or make available internet protocol addresses, network addresses, media access control (MAC) addresses, Internet addresses, or the like. As an example, the address elements 110 may be relied upon to establish communication sessions between the devices 102 and the network devices 116 or other devices and/or networks. As an example, each of the address elements 110 may be used as an identifier or locator of each of the devices 102. The address elements 110 may be persistent for a particular network.

The service elements 112 may comprise identification of the service providers associated with the devices 102 and/or with the class of devices 102. Each of the class of the devices 102 may be related to a type of device, a capability of a device, a type of service being offered, and/or a level of service (e.g., a business class, a service tier, a service package, etc.). As an example, each of the service elements 112 may comprise information relating to or made available by a communication service provider (e.g., an Internet service provider) that is offering or enabling data flow such as communication services to each of the devices 102. As an example, the service elements 112 may comprise information relating to a preferred service provider for one or more particular services relating to the devices 102. The address elements 110 may be used to identify or retrieve data from the service elements 112, or vice-versa. As an example, one or more of the address elements 110 and the service elements 112 can be stored remotely from the devices 102 and retrieved by one or more devices such as the devices 102 and the computing device 104. Other information can be represented by the service elements 112.

Each of the plurality of devices 102 may include an application 122 which may be partially or fully executed in a device environment of each device 102. The application 122 may be configured to provide Voice over Internet Protocol (VoIP) services allowing each device 102 to make a VoIP call to another device (e.g., another device 102). An application 122 of a first device 102 of the plurality of devices 102 may be configured to initiate a communication session (e.g., VoIP call) to a second device 102 of the plurality of devices 102. The communication session may be established via a first media server (e.g., first media server 140). In one example, a user of the first device 102 and/or a user of the second device 102 may provide user input indicating that a quality metric associated with the communication session has satisfied a threshold. In another example, the first device 102 and/or the second device 102 may determine (e.g., detect) that the quality metric has satisfied the threshold. In another example, a computing device (e.g., computing device 104) may determine (e.g., detect) that the quality metric has satisfied the threshold. For example, the quality metric may comprise one or more of a bandwidth, a delay, a packet loss rate, jitter, or a signal-to-noise ratio (SNR). As an example, the first device 102, the second device 102, and/or the computing device may determine that a bandwidth has fallen below a bandwidth threshold, that a delay has increased above a delay threshold, that a packet loss rate has increased above a packet loss rate threshold, that the jitter has increased above a jitter threshold, and/or that a SNR has decreased below a SNR threshold. Based on the quality metric associated with the communication session satisfying the threshold, the computing device may determine a second media server (e.g., second media server 142) for the communication session. The computing device may cause the communication session to continue via the second media server while maintaining the communication session via the first media server such that the communication session is not disconnected when the communication session is established through the second media server. After the communication session is established via the second media server, the computing device may cause the communication session via the first media server to drop (e.g., terminate).

The plurality of network devices 116 may be in communication with a network, such as network 105. The network devices 116 may be configured to allow one or more wireless devices to connect to a wired and/or wireless network using Wi-Fi, Bluetooth ®, Zigbee ®, or any desired method or standard. As an example, each of the network devices 116 may be configured to facilitate the connection of a device, such as a device 102 of the plurality of devices 102, to the network 105. Each of the network devices 116 may be configured as one or more of a set top box, a wireless access point (WAP), a gateway device, a combination thereof, or any device capable of providing content to a user device (e.g., a device 102). In an example, each of the network devices 116 may be configured as a set top box configured to output content items to a display device (e.g., a device 102). In an example, each of the network device s116 may be configured as a WAP to provide access to a wide area network (e.g., the Internet). For example, each of the network devices 116 may be configured to access the wide area network via a computing device (e.g., computing device 104, server, headend, Internet service provider, etc.). In an example, each of the network devices 116 may be configured to perform one or more gateway functions in order to provide the access to the wide area network. The one or more gateway functions may comprise one or more of network traffic routing, dynamic host configuration protocol (DHCP) management, VoIP functions, or IP streaming functions. In an example, each of the network devices 116 may be configured as a local network (e.g., local area network (LAN)) to provide, to each of the devices 102 access to the wide area network via the local network.

The network devices 116 may comprise identifiers 118. As an example, each of the identifiers 118 can be or relate to an Internet Protocol (IP) Address IPV4/IPV6 or a media access control address (MAC address) or the like. As a further example, the identifiers 118 may be unique identifiers for facilitating communications on the physical network segment. Each of the network devices 116 may comprise an identifier 118 that is distinct. As an example, each of the identifiers 118 may be associated with a physical location of each of the network device 116.

The computing device 104 may comprise a server, or a centralized device, for communicating with the network devices 116, or the devices 102, via the network device 116. In an example, the computing device 104 may communicate with the devices 102 for offering data and/or services. For example, the computing device 104 may offer services such as network (e.g., Internet) connectivity, network printing, media management (e.g., a media server), interference management, content services, streaming services, broadband services, or other network-related services.

The computing device 104 may allow the devices 102 to interact with remote resources such as data, devices, and files. As an example, the computing device 104 may be configured as (or disposed at) a central location (e.g., a headend, or a processing facility), which can receive content (e.g., data, input programming) from multiple sources. The computing device 104 may be a separate/remote device from the headend, for example. The computing device 104 can combine content from the multiple sources and may distribute the content to user (e.g., subscriber) locations via a distribution system.

The computing device 104 may be configured to manage the communication between the devices 102 and/or the network devices 116 and a storage system 114 for sending and receiving data therebetween. As an example, the storage system 114 may store a plurality of files, user identifiers or records, or other information. As a further example, the devices 102 may request and/or retrieve one or more files from the storage system 114. The storage system 114 may store information relating to the devices 102 such as the address elements 110 and/or the service elements 112. As an example, the computing device 104 may obtain the device identifiers 108 from the devices 102 and retrieve information from the storage system 114 such as the address elements 110 and/or the service elements 112. As a further example, the computing device 104 may obtain the address elements 110 from the devices 102 and may retrieve the service elements 112 from the storage system 114, or vice versa. As an example, the computing device 104 may obtain the identifiers 118 from the network devices 116 and retrieve information associated with the network devices 116 from the storage system 114. Any information can be stored in and retrieved from the storage system 114. The storage system 114 can be disposed remotely from the computing device 104 and accessed via direct or indirect connection. The storage system 114 can be integrated with the computing device 104 or some other device or system.

The computing device 104 may store server data 130 in the storage system 114. The server data 130 may comprise data associated with one or more media servers (e.g., media servers 140, 142) configured to provide communication services (e.g., Voice over IP (VoIP) services) to one or more user devices (e.g., devices 102). The server data 130 may comprise internet protocol (IP) addresses for identifying each media server 140, 142. In addition, the server data may comprise one or more parameters associated with each media 140, 142. The one or more parameters may comprise one or more of a bandwidth capability, a device load, a mean opinion score (MOS), a type of processor, an amount of memory, a number of active communication sessions, an amount of dropped communication sessions, an audio capability, a packet loss rate, an average latency, or a media server codec. The computing device 104 may rank each media server 140, 142 based on the one or more parameters for providing communication services to the one or more user devices.

The computing device 104 may be configured to reroute a communication session (e.g., VoIP call) via another, or a second, media server (e.g., media server 142) based on determining that a quality metric associated with the communication routed via a first media server 140 has satisfied a threshold. For example, a communication session may be initiated via a first media server 140. In one example, the computing device 104 may receive an indication of the quality metric from one or more of the user devices of the communication session. As an example, one or more of the user devices may receive user input indicating that the quality metric has satisfied the threshold and send the indication of the quality metric based on the user input. As an example, one or more of the user devices may determine (e.g., detect) that the quality metric has satisfied the threshold and send the indication of the quality metric based on determining that the quality metric has satisfied the threshold. In another example, the computing device 104 may determine (e.g., detect) that the quality metric has satisfied the threshold. As an example, one or more of the user devices, and/or the computing device 104 may determine that a bandwidth has fallen below a bandwidth threshold, that a delay has increased above a delay threshold, that a packet loss rate has increased above a packet loss rate threshold, that the jitter has increased above a jitter threshold, and/or that a SNR has decreased below a SNR threshold.

The computing device 104 may send an indication to migrate the communication session based on the quality metric associated with the communication session via the first media server 140 satisfying the threshold. In addition, the computing device 104 may determine a second media server 142 based on determining the indication to migrate the communication session via the first media server 140. For example, the computing device 104 may determine that the second media server 142 is the highest ranked media server based on ranking one or more media servers based on the one or more parameters. The computing device 104 may cause a first message to be sent to the second media server 142. The first message may comprise an identifier (e.g., IP address) of a user device (e.g., one of the plurality of devices 102) of the communication session. In addition, the computing device 104 may cause a second message to be sent to the user device. The second message may comprise an identifier (e.g., IP address) of the second media server 142. For example, the first message and the second message may each comprise a SIP invite message for initiating the communication session via the second media server 142. The computing device 104 may receive a response to the first message from the second media server 142. In addition, the computing device 104 may receive a response to the second message from the user device. The response to the first message and the response to the second message may each comprise a SIP 200 okay message acknowledging that the first message was received and the second message was received, respectively. Based on the response to the first message and the response to the second message, the computing device 104 may cause the communication session to continue via the second media server 142 during the communication session via the first media server 140. For example, the computing device 104 may cause the communication session to continue via the second media server 142 while maintaining the communication session via the first media server 140 based on the response to the first message and the response to the second message such that the communication session is not disconnected when the communication session is established through the second media server 142. The computing device 104 may cause the communication session via the first media server 140 to drop (e.g., terminate) after causing the communication session to continue via the second media server 142. For example, after causing the communication session to continue via the second media server 142, the computing device 104 may send a third message to the first media server 140 and receive a response to the third message from the first media server 140. The computing device 104 may cause the communication session via the first media server 140 to drop after receiving the response to the third message. The third message may comprise a SIP bye message and the response to the third message may comprise a SIP 200 okay message.

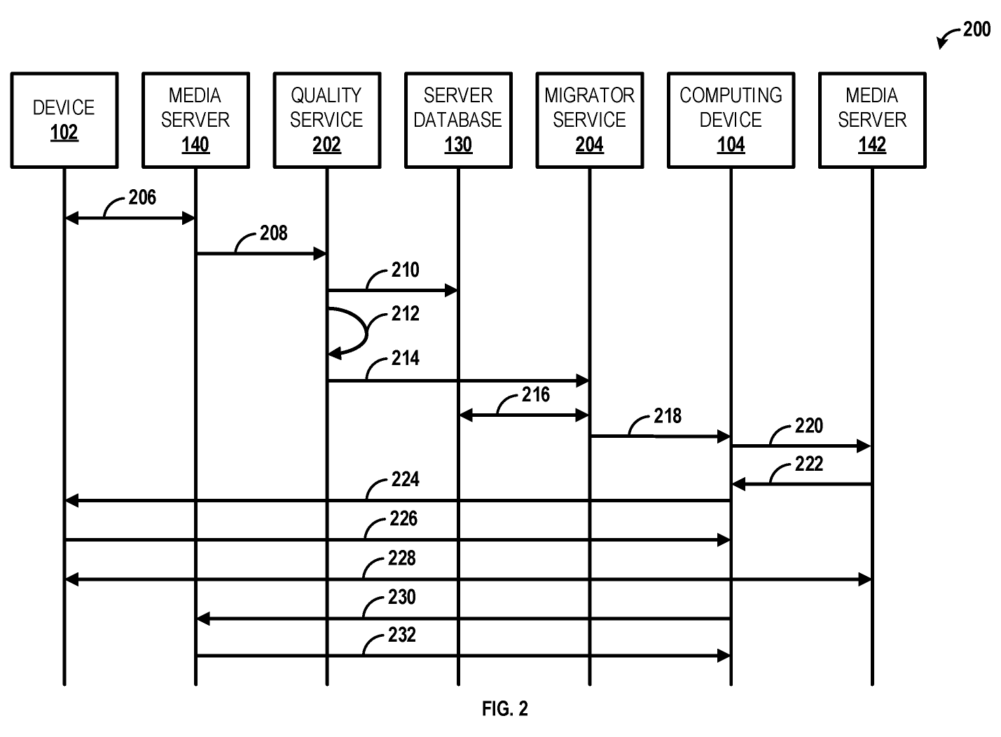

FIG. 2 shows an example communication session migration process 200. As an example, the communication session migration process 200 may be implemented by a device 102, a first media server 140, a quality control service 202, a server database 130, a migrator service 204, a computing device 104, and a second media server 142. As an example, the quality control service 202, the server database 130, the migrator service 204, and the computing device 104 may be independent devices or integrated together as the same device. At 206, the device 102 may initiate a communication session, via the first media server 140, with another user device. For example, the device 102 may initiate a VoIP call with the another device, wherein the VoIP call may be routed via the first media server 140 (e.g., via real-time transport protocol (RTP)) to the another device.

At 208, the first media server 140 may send quality control data to the quality control service 202 (e.g., via Google remote procedure call (gRPC)). As an example, the quality control data may include active communication session (e.g., VoIP call) data, host metrics (e.g., media server metrics), and/or data indicative of a number of active calls. As an example, the quality control data may comprise a quality metric associated with the communication session. The quality metric may comprise one or more of a bandwidth, a delay, a packet loss rate, jitter, or a signal-to-noise ratio (SNR). At 210, the quality control service 202 may forward the quality control data to the server database 130 (e.g., via gRPC). The sever database 130 may update one or more parameters, associated with one or more media servers (e.g., media servers 140, 142), based on the quality control data. As an example, the server database 130 may be configured to store server data associated with each media server. The server data may comprise internet protocol (IP) addresses for identifying each media server and one or more parameters associated with each media server. The one or more parameters may comprise one or more of a bandwidth capability, a device load, a mean opinion score (MOS), a type of processor, an amount of memory, a number of active communication sessions, an amount of dropped communication sessions, an audio capability, a packet loss rate, an average latency, or a media server codec. The server database 130 may rank the one or more media servers based on the one or more parameters.

At 212, the quality control service 202 may determine that the quality control data (e.g., quality metric) has satisfied a threshold. For example, the quality control service 202 may determine that a bandwidth has fallen below a bandwidth threshold, that a delay has increased above a delay threshold, that a packet loss rate has increased above a packet loss rate threshold, that jitter has increased above a jitter threshold, and/or that a SNR has decreased below a SNR threshold. At 214, based on determining that the quality control data has satisfied the threshold, the quality control service 202 may send an indication to migrate the communication session via the first media server 140 (e.g., via gRPC) to the migrator service 204. At 216, based on receiving the indication, the migrator service 204 may query the server database 130 for a new media server for the communication session. The server database 130 may return the highest ranked media server, or the second media server 142, to the migrator service 204. At 218, the migrator service 204 may forward (e.g., via gRPC) the indication to the computing device 104 (e.g., signaling gateway). In addition, for example, the migrator service 204 may send server information (e.g., IP address) of the second media server 142 to the computing device 104.

Based on the server information of the second media server 142, the computing device 104 may send a first message to the second media server 142 at 220. For example, the first message may comprise a SIP invite message including an IP address of the device 102. At 222, the second media server 142 may send a response to the first message to the computing device 104. For example, the response to the first message may comprise a SIP 200 okay message, including the IP address of the second media server 142, acknowledging that the SIP invite message was received. At 224, the computing device 104 may send a second message to the device 102. For example, the second message may comprise a SIP invite message including the IP address of the second media server 142. At 226, the device 102 may send a response to the second message to the computing device 104. For example, the response to the second message may comprise a SIP 200 okay message, including the IP address of the device 102, acknowledging that the SIP invite message was received.

At 228, the communication session may be established, or may continue, via the second media server 142 based on the response to the first message and the response to the second message. For example, the communication session via the second media server 142 may be established while maintaining the communication session via the first media server 140. The computing device 104 may send a third message to the first media server 140 after establishing the communication session via the second media server 142, at 230, such that the communication session is not disconnected when the communication session is established through the second media server 142. For example, the third message may comprise a SIP bye message initiating the termination of the communication session via the first media server 140. At 232, the first media server 140 may send a response to the third message to the computing device 104 dropping (e.g., terminating) the communication session via the first media server 140. As an example, by maintaining the communication session via the first media server 140 while establishing the communication session via the second media server 142, the communication session (e.g., VoIP call) between the device 102 and the another device may be switched from being routed via the first media server 140 to being routed via the second media server 142 without disconnecting the communication session between the device 102 and the another device.

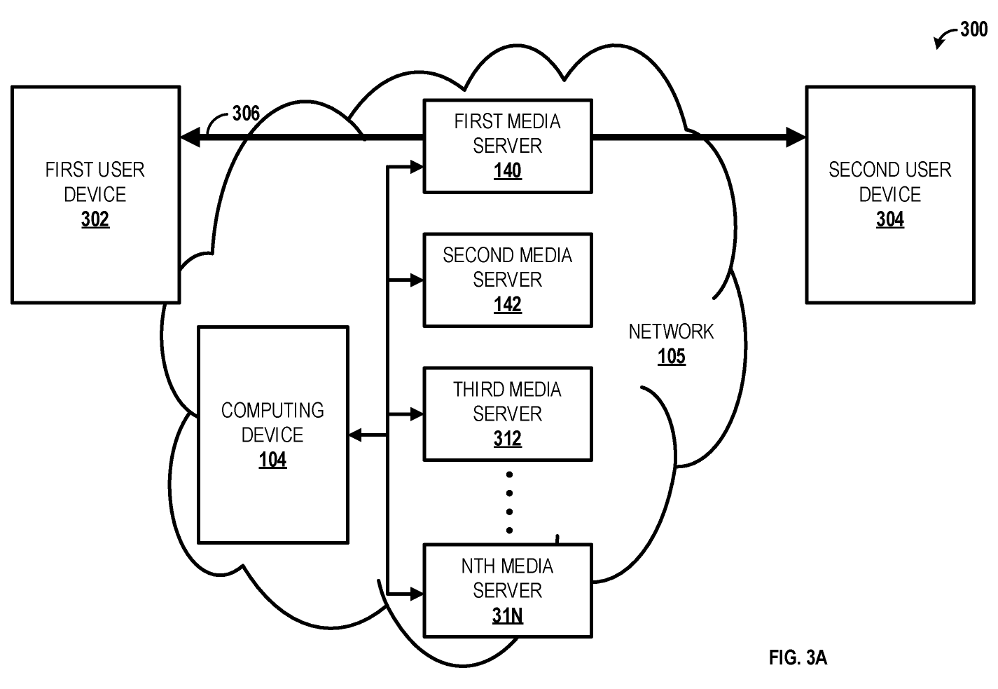

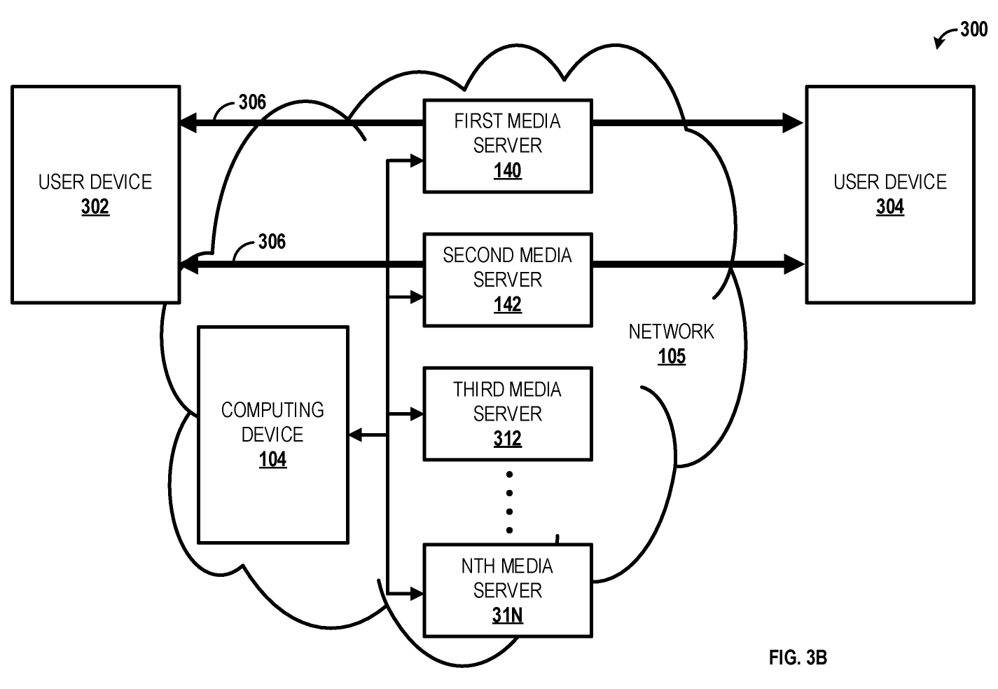

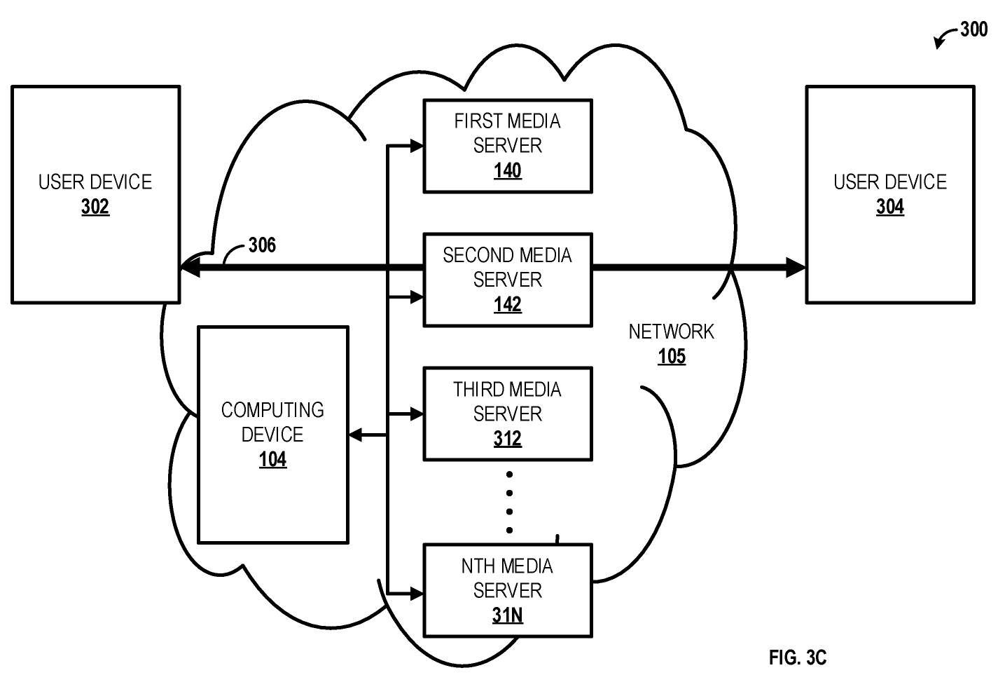

FIGS. 3A-3C show an example communication session migration scenario 300. A first user device 302 may initiate a communication session 306, via a first media server 140, with a second user device 304. As shown in FIG. 3A, the first user device 302 may initiate a VoIP call with the second user device 304, wherein the VoIP call may be routed via the first media server 140. The computing device 104 may monitor the communication session 306 to determine whether a quality metric associated with the communication session 306 has satisfied a threshold. The quality metric may comprise one or more of a bandwidth, a delay, a packet loss rate, jitter, or a signal-to-noise ratio (SNR). As an example, the computing device 104 may determine that a bandwidth has fallen below a bandwidth threshold, that a delay has increased above a delay threshold, that a packet loss rate has increased above a packet loss rate threshold, that jitter has increased above a jitter threshold, and/or that a SNR has decreased below a SNR threshold. The computing device 104 may also use the quality metric to update one or more parameters associated with one or more media servers (e.g., first media server 140, second media server 142, third media server 312, up to an N number of media servers 31N). The one or more parameters may comprise one or more of a bandwidth capability, a device load, a mean opinion score (MOS), a type of processor, an amount of memory, a number of active communication sessions, an amount of dropped communication sessions, an audio capability, a packet loss rate, an average latency, or a media server codec. The computing device 104 may rank the one or more media servers based on the one or more parameters. Based on determining that the quality metric has satisfied the threshold, the computing device 104 may cause the communication session 306 to continue via the second media server 142 during the communication session 306 via the first media server 140, as shown in FIG. 3B. As an example, the computing device 104 may determine that the second media server 142 is the highest ranked media server. Based on determining that the second media server 142 is the highest ranked media server, the computing device 104 may establish the communication session 306 via the second media server 142.

As an example, the computing device 104 may cause a first message to be sent to the second media server 142. The first message may comprise an identifier (e.g., IP address) of the first user device 302 of the communication session 306. In addition, the computing device 104 may cause a second message to be sent to the first user device 302. The second message may comprise an identifier (e.g., IP address) of the second media server 142. As an example, the first message and the second message may each comprise a SIP invite message for initiating the communication session 306 via the second media server 142. The computing device 104 may receive a response to the first message from the second media server 142. In addition, the computing device 104 may receive a response to the second message from the first user device 302. The response to the first message and the response to the second message may each comprise a SIP 200 okay message acknowledging that the first message was received and the second message was received, respectively. Based on the response to the first message and the response to the second message, the computing device 104 may cause the communication session 306 to continue via the second media server 142 during the communication session 306 via the first media server 140. For example, the computing device 104 may cause the communication session 306 to continue via the second media server 142 while maintaining the communication session 306 via the first media server 140 based on the response to the first message and the response to the second message such that the communication session is not disconnected when the communication session is established through the second media server 142. The computing device 104 may cause the communication session 306 via the first media server 140 to drop (e.g., terminate) after causing the communication session 306 to continue via the second media server 142, as shown in FIG. 3C. For example, after causing the communication session 306 to continue via the second media server 142, the computing device 104 may send a third message to the first media server 140 and receive a response to the third message from the first media server 140. The computing device 104 may cause the communication session 306 via the first media server 140 to drop after receiving the response to the third message. The third message may comprise a SIP bye message and the response to the third message may comprise a SIP 200 okay message.

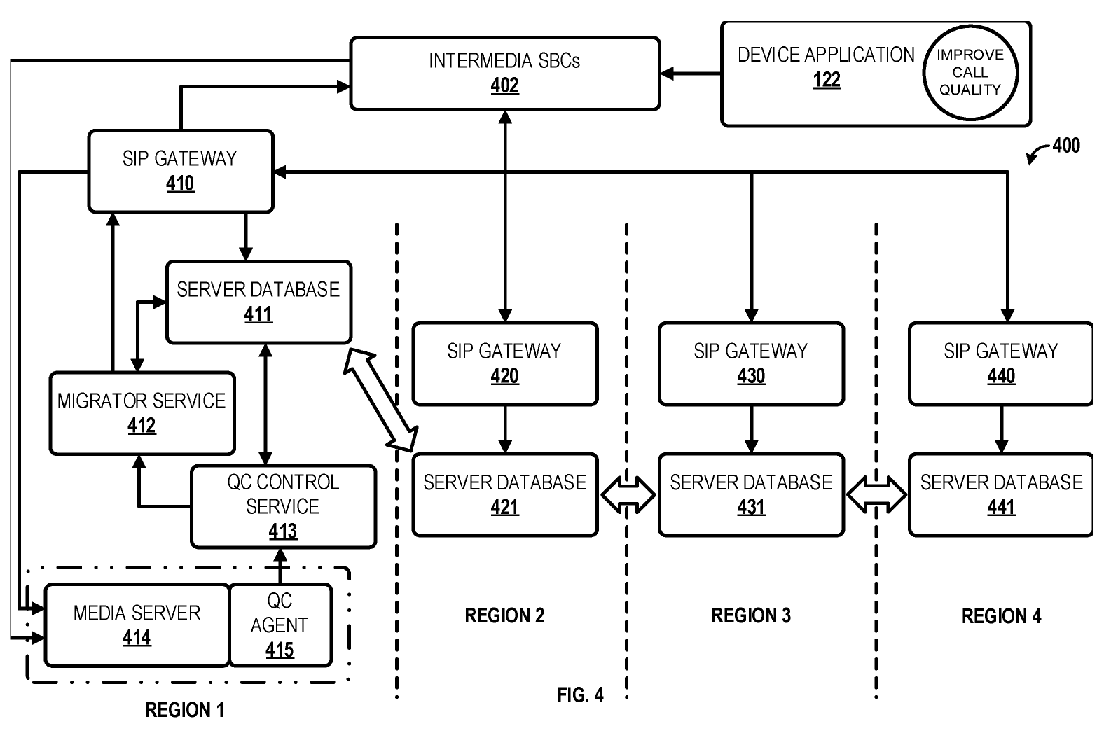

FIG. 4 shows an example system environment 400. The system environment 400 may comprise a device application 122 implemented by a user device (e.g., one of the devices 102), one or more intermediate session board controllers (SBCs) 402, one or more SIP gateways 410, 420, 430, 440, one or more server databases 411, 421, 431, 441, one or more migrator services 412, one or more quality control services 413, one or more media servers 414, and one or more quality control agents 415. A user device may be configured to implement a device application 122 to initiate a communication session (e.g., VoIP call) with another user device. At least one of the intermedia SBCs 402 may route the communication session via the SIP gateway 410 based on a location of the user device in order to initiate the communication session. The SIP gateway 410 may establish the communication session via the media server 414. As an example, the quality control agent 415 may be implemented together with the media server 414 as a virtual machine.

The quality control agent 415 may send quality control data to the quality control service 413. As an example, the quality control data may include active communication session (e.g., VoIP call) data, host metrics (e.g., media server metrics), and/or data indicative of a number of active calls. As an example, the quality control data may comprise a quality metric associated with the communication session. The quality metric may comprise one or more of a bandwidth, a delay, a packet loss rate, jitter, or a signal-to-noise ratio (SNR). The quality control service 413 may forward the quality control data to the server database 411, wherein the sever database 411 may update one or more parameters, associated with one or more media servers (e.g., media server 414), based on the quality control data. As an example, the server database 411 may be configured to store server data associated with each media server. The server data may comprise internet protocol (IP) addresses for identifying each media server and the one or more parameters associated with each media server. The one or more parameters may comprise one or more of a bandwidth capability, a device load, a mean opinion score (MOS), a type of processor, an amount of memory, a number of active communication sessions, an amount of dropped communication sessions, an audio capability, a packet loss rate, an average latency, or a media server codec. The server database 411 may rank the one or more media servers based on the one or more parameters.

The quality control service 413 may also determine that the quality control data (e.g., quality metric) has satisfied a threshold. For example, the quality control service 413 may determine that a bandwidth has fallen below a bandwidth threshold, that a delay has increased above a delay threshold, that a packet loss rate has increased above a packet loss rate threshold, that jitter has increased above a jitter threshold, and/or that a SNR has decreased below a SNR threshold. Based on determining that the quality control data has satisfied the threshold, the quality control service 413 may send an indication to migrate the communication session via the first media server 140 to the migrator service 412. Based on receiving the indication, the migrator service 413 may query the server database 411 for a new media server for the communication session. The server database 411 may return the highest ranked media server to the migrator service 204. The migrator service 204 may forward the indication to the computing device 104 in addition to server information (e.g., IP address) of the new media server to the SIP gateway 410.

Based on the server information of the new media server, the SIP gateway 410 may send a first message to the new media server and the new media server may send a response to the first message to the SIP gateway 410. For example, the first message may comprise a SIP invite message including an IP address of the user device and the response to the first message may comprise a SIP 200 okay message, including the IP address of the new media server, acknowledging that the SIP invite message was received. In addition, the SIP gateway 410 may send a second message to the user device and the user device may send a response to the second message to the SIP gateway 410. For example, the second message may comprise a SIP invite message including the IP address of the new media server and the response to the second message may comprise a SIP 200 okay message, including the IP address of the user device, acknowledging that the SIP invite message was received.

Based on the response to the first message and the response to the second message, the communication session may be established, or may continue, via the new media server. For example, the communication session via the new media server may be established while maintaining the communication session via the media server 414 such that the communication session is not disconnected when the communication session is established through the new media server. The SIP gateway 410 may send a third message to the media server 414 after establishing the communication session via the new media server. For example, the third message may comprise a SIP bye message initiating the termination of the communication session via the media server 414. The media server 414 may send a response to the third message to the SIP gateway 410 dropping (e.g., terminating) the communication session via the media server 414. As an example, by maintaining the communication session via the media server 414 while establishing the communication session via the new media server, the communication session (e.g., VoIP call) may be switched from being routed via the media server 414 to being routed via the new media server without disconnecting the communication session.

Each SIP gateway 410, 420, 430, 440 may be located in and service a different region (e.g., Region 1, Region 2, Region 3, Region 4, etc.). As an example, as shown in FIG. 4, the first SIP gateway 410 may be located in and service a first region, the second SIP gateway 420 may be located in and service a second region, the third SIP gateway 430 may be located in and service a third region, and the fourth SIP gateway 440 may be located in and service a fourth region. Each SIP gateway in each region may be configured to retrieve server data from a server database 411, 421, 431, 441. The server data stored in the server database 411 may be duplicated and stored in each of the databases 421, 431, 441. Each of the Regions 2, 3, 4 may include a migrator service, a quality control service, a media server, and a quality control agent. For example, each SIP gateway 420, 430, 440 may be configured to management separate communications sessions (e.g., VoIP) in a similar manner as the SIP gateway 410. For example, each SIP gateway 420, 430, 440 may monitory quality data associated with each corresponding communication session routed via each corresponding media server in order to determine whether each communication session needs to be migrated to a different media server. In an example, each SIP gateway 410, 420, 430, 440 may be configured to receive quality data of all media servers in each region. If all media servers of a region are experiencing quality issues, the communication session of that corresponding region may be routed via another region (e.g., another SIP gateway 410, 420, 430, 440).

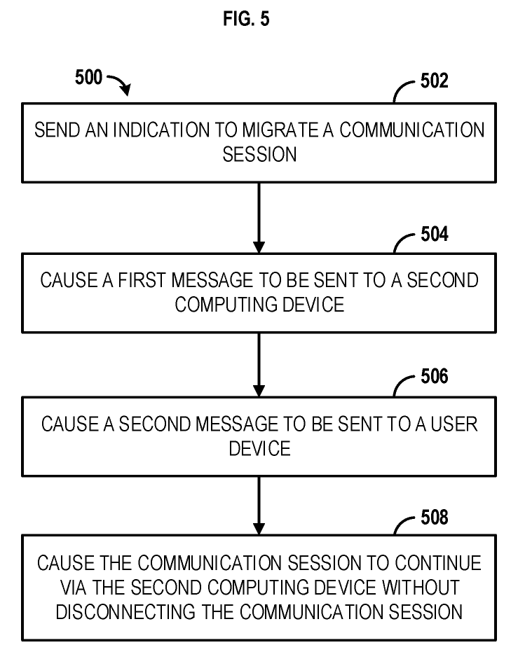

FIG. 5 shows a flowchart of an example method 500 for managing the connection quality of a communication session. Method 500 may be implemented, for example, by a device (e.g., one or more devices 102, a computing device 104, etc.). At step 502, an indication to migrate a communication session via a first computing device may be sent based on a quality metric associated with the communication session via the first computing device. For example, a device (e.g., one or more devices 102, a computing device 104, etc.) may send the indication to migrate the communication session via the first computing device based on the quality metric associated with the communication session via the first computing device. The communication session may comprise a Voice over Internet Protocol (VoIP) call. The quality metric may comprise one or more of a bandwidth, a delay, a packet loss rate, jitter, or a signal-to-noise ratio (SNR). A second computing device may be determined based on the indication. For example, based on the indication, the second computing device may be determined based on one or more computing devices ranked according to one or more parameters. For example, the second computing may be determined based on the second computing being a highest ranked computing device of the one or more computing devices. The one or more parameters may comprise one or more of a bandwidth capability, a device load, a mean opinion score (MOS), a type of processor, an amount of memory, a number of active communication sessions, an amount of dropped communication sessions, an audio capability, a packet loss rate, an average latency, or a media server codec.

As an example, the indication may be sent based on determining that the quality metric has satisfied a threshold. For example, it may be determined that a bandwidth has fallen below a bandwidth threshold, that a delay has increased above a delay threshold, that a packet loss rate has increased above a packet loss rate threshold, that jitter has increased above a jitter threshold, and/or that a SNR has decreased below a SNR threshold. In one example, user input indicating that the quality metric has satisfied the threshold may be received. In another example, the device may determine/detect that the quality metric has satisfied the threshold.

At step 504, a first message may be sent to the second computing device. For example, the device (e.g., one or more devices 102, a computing device 104, etc.) may cause the first message to be sent to the second computing device. The first message may comprise an identifier (e.g., IP address) of a user device of the communication session. In an example, the first message may comprise a SIP invite message.

At step 506, a second message may be sent to the user device. For example, the device (e.g., one or more devices 102, a computing device 104, etc.) may cause the second message to be sent to the user device. The second message may comprise an identifier (e.g., IP address) of the second computing device of the communication session. In an example, the second message may comprise a SIP invite message.

At step 508, the communication session may be caused to continue via the second computing device during the communication session via the first computing device without disconnecting the communication session based on a response to the first message and a response to the second message. For example, the device (e.g., one or more devices 102, a computing device 104, etc.) may cause the communication session to continue via the second computing device during the communication session via the first computing device without disconnecting the communication session based on a response to the first message and a response to the second message. The response to the first message and/or the response to the second message may comprise a SIP 200 okay message. As an example, causing the communication session to continue via the second computing device during the communication session via the first computing device based on the response to the first message and the response to the second message may comprise causing the communication session to continue via the second computing device while maintaining the communication session via the first computing device based on the response to the first message and the response to the second message. As an example, the communication session via the first computing device may be dropped (e.g., terminated) after causing the communication session to continue via the second computing device. For example, by maintaining the communication session via the first computing device while establishing the communication session via the second computing device, the communication session may be switched from being routed via the first computing device to being routed via the second computing device without disconnecting the communication session.

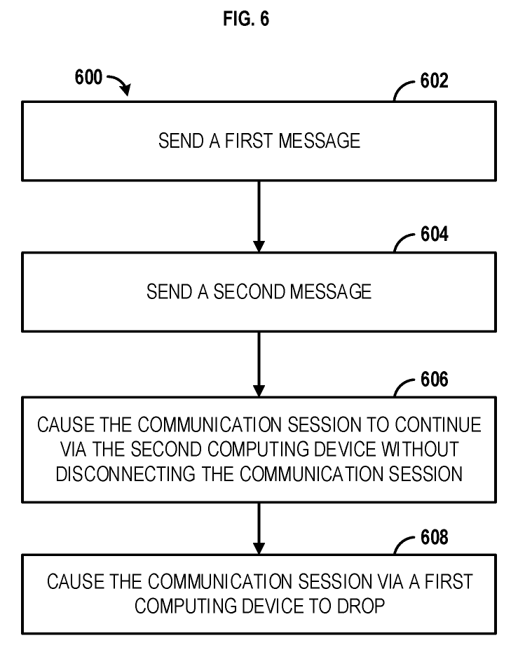

FIG. 6 shows a flowchart of an example method 600 for managing the connection quality of a communication session. Method 600 may be implemented, for example, by a device (e.g., one or more devices 102, a computing device 104, etc.). At step 602, a first message comprising an identifier of a user device of a communication session via a first computing device may be sent to a second computing device based on a quality metric associated with the communication session via the first computing device. For example, a device (e.g., one or more devices 102, a computing device 104, etc.) may send the first message comprising the identifier of the user device of the communication session via the first computing device to the second computing device based on the quality metric associated with the communication session via the first computing device. The quality metric may comprise one or more of a bandwidth, a delay, a packet loss rate, jitter, or a signal-to-noise ratio (SNR). The communication session may comprise a Voice over Internet Protocol (VoIP) call. The first message may comprise a SIP invite message.

As an example, the second computing device may be determined based on the quality metric associated with the communication session via the first computing device. For example, based on the quality metric, the second computing device may be determined based on one or more computing devices ranked according to one or more parameters. For example, the second computing may be determined based on the second computing being a highest ranked computing device of the cone or more computing devices. The one or more parameters may comprise one or more of a bandwidth capability, a device load, a mean opinion score (MOS), a type of processor, an amount of memory, a number of active communication sessions, an amount of dropped communication sessions, an audio capability, a packet loss rate, an average latency, or a media server codec.

As an example, the first message may be sent based on determining that the quality metric has satisfied a threshold. For example, it may be determined that a bandwidth has fallen below a bandwidth threshold, that a delay has increased above a delay threshold, that a packet loss rate has increased above a packet loss rate threshold, that jitter has increased above a jitter threshold, and/or that a SNR has decreased below a SNR threshold. In one example, user input indicating that the quality metric has satisfied the threshold may be received. In another example, the device may determine/detect that the quality metric has satisfied the threshold.

At step 604, a second message comprising an identifier of the second computing device may be sent to the user device. For example, a device (e.g., one or more devices 102, a computing device 104, etc.) may send the second message comprising the identifier of the second computing device to the user device. The second message may comprise a SIP invite message.

At step 606, the communication session may be caused to continue via the second computing device during the communication session via the first computing device without disconnecting the communication session based on a response to the first message and a response to the second message. For example, the device (e.g., one or more devices 102, a computing device 104, etc.) may cause the communication session to continue via the second computing device during the communication session via the first computing device without disconnecting the communication session based on the response to the first message and the response to the second message. The response to the first message and/or the response to the second message may comprise a SIP 200 okay message. As an example, causing the communication session to continue via the second computing device during the communication session via the first computing device based on the response to the first message and the response to the second message may comprise causing the communication session to continue via the second computing device while maintaining the communication session via the first computing device based on the response to the first message and the response to the second message.

At step 608, the communication session via the first computing device may be caused to drop (e.g., terminate) based on the communication session continuing via the second computing device. For example, the device (e.g., one or more devices 102, a computing device 104, etc.) may cause the communication session via the first computing device to drop based on the communication session continuing via the second computing device. For example, by maintaining the communication session via the first computing device while establishing the communication session via the second computing device, the communication session may be switched from being routed via the first computing device to being routed via the second computing device without disconnecting the communication session.

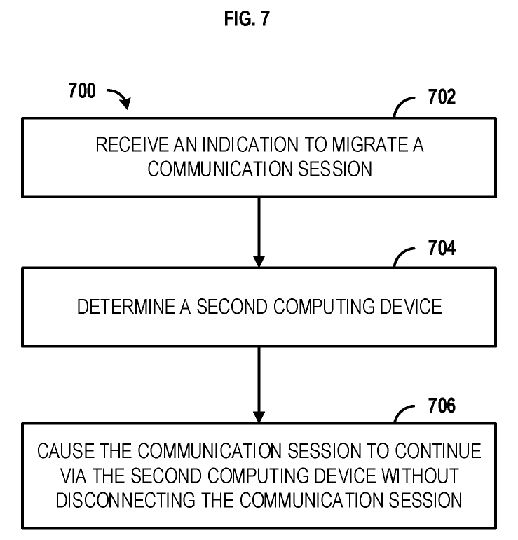

FIG. 7 shows a flowchart of an example method 700 for managing the connection quality of a communication session. Method 700 may be implemented, for example, by a device (e.g., one or more devices 102, a computing device 104, etc.). At step 702, an indication to migrate a communication session via a first computing device may be received based on a quality metric associated with the communication session via the first computing device. For example, a device (e.g., one or more devices 102, a computing device 104, etc.) may receive the indication to migrate the communication session via the first computing device based on the quality metric associated with the communication session via the first computing device. The quality metric may comprise one or more of a bandwidth, a delay, a packet loss rate, jitter, or a signal-to-noise ratio (SNR). The communication session may comprise a Voice over Internet Protocol (VoIP) call.

At step 704, an identifier of a second computing device may be determined based on the indication. For example, the device (e.g., one or more devices 102, a computing device 104, etc.) may determine the identifier of the second computing device based on the indication. A first message comprising an identifier of a user device of the communication session may be sent to the second computing device and a second message comprising the identifier of the second computing device may be sent to the user device. In an example, the first message and/or the second message may comprise a SIP invite message. As an example, a ranking of each computing device of one or more computing devices may be determined based on one or more parameters associated with the one or more computing devices. The second computing may be determined based on the second computing being a highest ranked computing device of the cone or more computing devices. The one or more parameters may comprise one or more of a bandwidth capability, a device load, a mean opinion score (MOS), a type of processor, an amount of memory, a number of active communication sessions, an amount of dropped communication sessions, an audio capability, a packet loss rate, an average latency, or a media server codec.

At step 706, the communication session may be caused to continue via the second computing device during the communication session via the first computing device without disconnecting the communication session based on a response to the first message and a response to the second message. For example, the device (e.g., one or more devices 102, a computing device 104, etc.) may cause the communication session to continue via the second computing device during the communication session via the first computing device without disconnecting the communication session based on the response to the first message and the response to the second message. The response to the first message and/or the response to the second message may comprise a SIP 200 okay message. As an example, causing the communication session to continue via the second computing device during the communication session via the first computing device based on the response to the first message and the response to the second message may comprise causing the communication session to continue via the second computing device while maintaining the communication session via the first computing device based on the response to the first message and the response to the second message. As an example, the communication session via the first computing device may be dropped (e.g., terminated) after causing the communication session to continue via the second computing device. For example, by maintaining the communication session via the first computing device while establishing the communication session via the second computing device, the communication session may be switched from being routed via the first computing device to being routed via the second computing device without disconnecting the communication session.

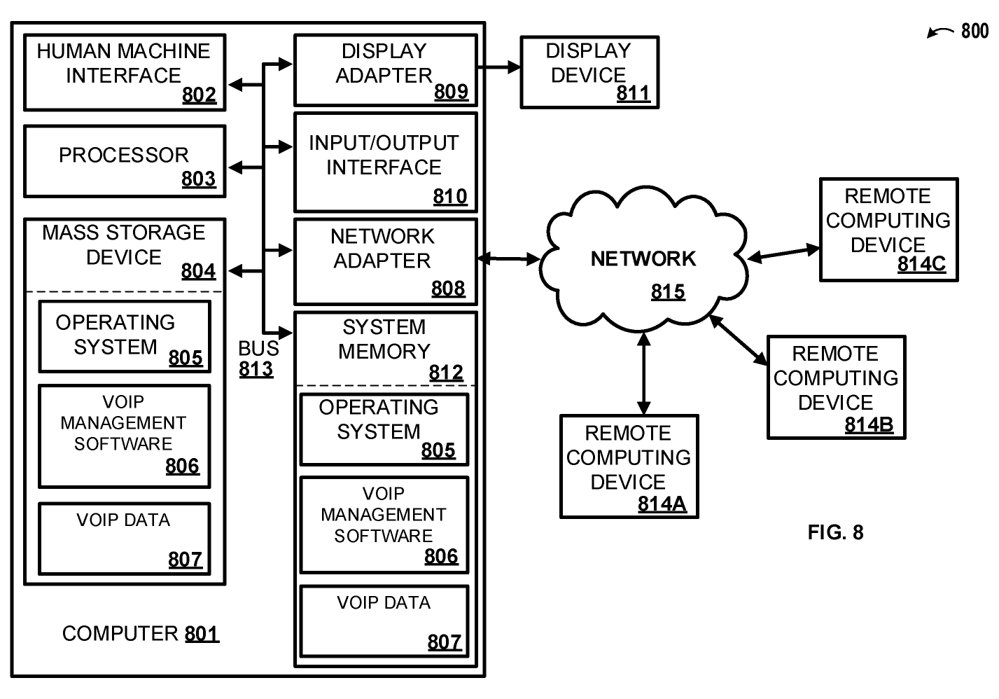

FIG. 8 is a block diagram illustrating an example computing device. The methods and systems can be implemented on a computer 801 as illustrated in FIG. 8 and described below. By way of example, the one or more devices 102, the one or more network devices 116, and the computing device 104 of FIG. 1 can be a computer 801 as illustrated in FIG. 8. Similarly, the methods and systems disclosed can utilize one or more computers to perform one or more functions in one or more locations. FIG. 8 is a block diagram illustrating an exemplary operating environment 800 for performing the disclosed methods. This exemplary operating environment 800 is only an example of an operating environment and is not intended to suggest any limitation as to the scope of use or functionality of operating environment architecture. Neither should the operating environment 800 be interpreted as having any dependency or requirement relating to any one or combination of components illustrated in the exemplary operating environment 800.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media including memory storage devices.

Further, one skilled in the art will appreciate that the systems and methods disclosed herein can be implemented via a general-purpose computing device in the form of a computer 801. The computer 801 can comprise one or more components, such as one or more processors 803, a system memory 812, and a bus 813 that couples various components of the computer 801 including the one or more processors 803 to the system memory 812. In the case of multiple processors 803, the system can utilize parallel computing.

The bus 813 can comprise one or more of several possible types of bus structures, such as a memory bus, memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 813, and all buses specified in this description can also be implemented over a wired or wireless network connection and one or more of the components of the computer 801, such as the one or more processors 803, a mass storage device 804, an operating system 805, VoIP management software 806, VoIP data 807, a network adapter 808, system memory 812, an Input/Output Interface 810, a display adapter 809, a display device 811, and a human machine interface 802, can be contained within one or more remote computing devices 814A-814C at physically separate locations, connected through buses of this form, in effect implementing a fully distributed system.

The computer 801 typically comprises a variety of computer readable media. Exemplary readable media can be any available media that is accessible by the computer 801 and comprises, for example and not meant to be limiting, both volatile and non-volatile media, removable and non-removable media. The system memory 812 can comprise computer readable media in the form of volatile memory, such as random access memory (RAM), and/or non-volatile memory, such as read only memory (ROM). The system memory 812 typically can comprise data such as VoIP data 807 and/or program modules such as operating system 805 and VoIP management software 806 that are accessible to and/or are operated on by the one or more processors 803.

The computer 801 can also comprise other removable/non-removable, volatile/non-volatile computer storage media. By way of example, the computer 801 can comprise a mass storage device 804 which can offer non-volatile storage of computer code, computer readable instructions, data structures, program modules, and other data for the computer 801. For example, a mass storage device 804 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 804, including by way of example, an operating system 805 and VoIP management software 806. One or more of the operating system 805 and VoIP management software 806 (or some combination thereof) can comprise elements of the programming and the VoIP management software 806. VoIP data 807 can also be stored on the mass storage device 804. VoIP data 807 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple locations within the network 815.

The user can enter commands and information into the computer 801 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices can be connected to the one or more processors 803 via a human machine interface 802 that is coupled to the bus 813, but can be connected by other interface and bus structures, such as a parallel port, game port, an IEEE 1394 Port (also known as a Firewire port), a serial port, network adapter 808, and/or a universal serial bus (USB).

A display device 811 can also be connected to the bus 813 via an interface, such as a display adapter 809. It is contemplated that the computer 801 can have more than one display adapter 809 and the computer 801 can have more than one display device 811. For example, a display device 811 can be a monitor, an LCD (Liquid Crystal Display), light emitting diode (LED) display, television, smart lens, smart glass, and/ or a projector. In addition to the display device 811, other output peripheral devices can comprise components such as speakers (not shown) and a printer (not shown) which can be connected to the computer 801 via Input/Output Interface 810. Any step and/or result of the methods can be output in any form to an output device. Such output can be any form of visual representation, including, but not limited to, textual, graphical, animation, audio, tactile, and the like. The display 811 and computer 801 can be part of one device, or separate devices.

The computer 801 can operate in a networked environment using logical connections to one or more remote computing devices 814A, 814B, and 814C. By way of example, a remote computing device 814A-814C can be a personal computer, a computing station (e.g., a workstation), a portable computer (e.g., a laptop, a mobile phone, a tablet device), a smart device (e.g., a smartphone, a smart watch, an activity tracker, a smart apparel, a smart accessory), a security and/or monitoring device, a server, a router, a network computer, a peer device, an edge device or other common network node, and so on. Logical connections between the computer 801 and a remote computing device 814A-814C can be made via a network 815, such as a local area network (LAN) and/or a general wide area network (WAN). Such network connections can be through a network adapter 808. A network adapter 808 can be implemented in both wired and wireless environments. Such networking environments are conventional and commonplace in dwellings, offices, enterprise-wide computer networks, intranets, and the Internet.

For purposes of illustration, application programs and other executable program components such as the operating system 805 are illustrated herein as discrete blocks, although it is recognized that such programs and components can reside at various times in different storage components of the computer 801, and are executed by the one or more processors 803 of the computer 801. An implementation of VoIP management software 806 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence (AI) techniques such as machine learning and iterative learning. Examples of such techniques include, but are not limited to, expert systems, case based reasoning, Bayesian networks, behavior based AI, neural networks, fuzzy systems, evolutionary computation (e.g., a genetic algorithms), swarm intelligence (e.g., an ant algorithms), and hybrid intelligent systems (e.g., expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method comprising:
monitoring a quality metric associated with a communication session between a user device and a destination device via a first computing device;
sending, based on the quality metric, an indication to migrate the communication session from the first computing device to a determined second computing device;
causing a first message to be sent to the determined second computing device and a second message to be sent to the user device; and
causing, during the communication session via the first computing device, after a response to the first message and a response to the second message, the communication session to continue via the determined second computing device.

2. The method of claim 1, wherein the communication session comprises a Voice over Internet Protocol (VoIP) call.

3. The method of claim 1, wherein the quality metric comprises one or more of a bandwidth, a delay, a packet loss rate, jitter, or a signal-to-noise ratio (SNR).

4. The method of claim 1, wherein the second computing device is determined based on one or more computing devices ranked according to one or more parameters, wherein the determined second computing device comprises a highest ranked computing device of the one or more computing devices.

5. The method of claim 4, wherein the one or more parameters comprise one or more of a bandwidth capability, a device load, a mean opinion score (MOS), a type of processor, an amount of memory, a number of active communication sessions, an amount of dropped communication sessions, an audio capability, a packet loss rate, an average latency, or a media server codec.

6. The method of claim 1, wherein one or more of the first message or the second message comprises a SIP invite message, and wherein one or more of the response to the first message or the response to the second message comprises a SIP 200 okay message.

7. The method of claim 1, wherein causing, during the communication session via the first computing device, the communication session to continue via the determined second computing device comprises causing, while maintaining the communication session via the first computing device, the communication session to continue via the determined second computing device.

8. The method of claim 1, wherein the communication session via the first computing device is dropped after causing the communication session to continue via the determined second computing device.

9. A method comprising:
monitoring a quality metric associated with a communication session between a user device and a destination device via a first computing device;
sending, based on the quality metric, a first message to a determined second computing device and a second message to the user device;
causing, during the communication session via the first computing device, after a response to the first message and a response to the second message, the communication session to continue via the determined second computing device; and
causing, based on the communication session continuing via the determined second computing device, the communication session via the first computing device to drop.

10. The method of claim 9, wherein sending, based on the quality metric, the first message to the determined second computing device comprises:
determining, based on the quality metric, the second computing device; and
sending the first message to the determined second computing device.

11. The method of claim 9, wherein the quality metric comprises one or more of a bandwidth, a delay, a packet loss rate, jitter, or a signal-to-noise ratio (SNR).

12. The method of claim 9, wherein the communication session comprises a Voice over Internet Protocol (VoIP) call.

13. The method of claim 9, wherein the second computing device is determined based on one or more computing devices ranked according to one or more parameters, wherein the determined second computing device comprises a highest ranked computing device of the one or more computing devices.

14. The method of claim 13, wherein the one or more parameters comprise one or more of a bandwidth capability, a device load, a mean opinion score (MOS), a type of processor, an amount of memory, a number of active communication sessions, an amount of dropped communication sessions, an audio capability, a packet loss rate, an average latency, or a media server codec.

15. The method of claim 9, wherein one or more of the first message or the second message comprises a SIP invite message, and wherein one or more of the response to the first message or the response to the second message comprises a SIP 200 okay message.

16. The method of claim 9, wherein causing, during the communication session via the first computing device, the communication session to continue via the determined second computing device comprises causing, while maintaining the communication session via the first computing device, the communication session to continue via the determined second computing device.

17. A method comprising:
monitoring a quality metric associated with a communication session between a user device and a destination device via a first computing device;
receiving, based on the quality metric, an indication to migrate the communication session;
determining, based on the indication, a determined second computing device, wherein a first message is sent to the determined second computing device and a second message is sent to the user device; and
causing, during the communication session via the first computing device, after a response to the first message and a response to the second message, the communication session to continue via the determined second computing device.

18. The method of claim 17, further comprising:
determining, based on one or more parameters associated with one or more computing devices, a ranking of each computing device of the one or more computing devices; and
determining, based on the ranking of each computing device, the second computing device, wherein the determined second computing device comprises a highest ranked computing device of the one or more computing devices.

19. The method of claim 18, wherein the one or more parameters comprise one or more of a bandwidth capability, a device load, a mean opinion score (MOS), a type of processor, an amount of memory, a number of active communication sessions, an amount of dropped communication sessions, an audio capability, a packet loss rate, an average latency, or a media server codec.

20. The method of claim 17, wherein the quality metric comprises one or more of a bandwidth, a delay, a packet loss rate, jitter, or a signal-to-noise ratio (SNR).

21. The method of claim 17, wherein the communication session comprises a Voice over Internet Protocol (VoIP) call.

22. The method of claim 17, wherein one or more of the first message or the second message comprises a SIP invite message, and wherein one or more of the to the first message or the response to the second message comprises a SIP 200 okay message.

23. The method of claim 17, wherein causing, during the communication session via the first computing device, the communication session to continue via the determined second computing device comprises causing, while maintaining the communication session via the first computing device, the communication session to continue via the determined second computing device.

24. The method of claim 17, wherein the communication session via the first computing device is dropped after causing the communication session to continue via the determined second computing device.
